(19) United States
(12) Patent Application Publication
(10) Pub. No.: US 2009/0070274 A1
(43) Pub. Date: Mar. 12, 2009

(54) Method and system for identification and analysis of investment assets

(75) Inventors: Paul A. Bukowski, West Hartford, CT (US); Kurt S. Cubbage, West Hartford, CT (US); Hugh T.M. Whelan, West Hartford, CT (US)

Correspondence Address: WARD & OLIVO, SUITE 300, 382 SPRINGFIELD AVENUE, SUMMIT, NJ, 07901, US

(73) Assignee: HARTFORD FIRE INSURANCE COMPANY

(21) Appl. No.: 11/900,448

(22) Filed: Sep. 11, 2007

(51) Int. Cl. G06Q 40/00; G06F 17/10; G06F 17/30; G06F 17/40

(52) U.S. Cl. 705/36 R; 705/39

(57) ABSTRACT

The present invention discloses a novel method and system for identification and analysis of fundamental stock characteristics, as well as investment funds distribution. Essential stock performance factors are identified and characterized, the identified factors are then divided by sectors. The weight on the stock selection decision of each factor is then identified based, in part, on how indicative the factor is of actual stock performance. Stocks are then purchased according to this selection method, and the unique fund division method of the present invention.

### FIELD OF THE INVENTION

The present invention generally relates to the field of investments. More specifically, the present invention discloses a novel system for computerized identification and analysis of fundamental asset performance characteristics, as well as a computerized system for the selection and purchase of assets based on intensive analysis and characterization.

### BACKGROUND OF THE INVENTION

Individuals or groups seeking to maximize their returns from an investment in an asset (i.e. stock options, futures, money markets, etc,) may seek to expand their gains through adjustment of a known investment strategy. Additionally, these individuals or groups may seek to use well known investment strategies with a targeted level of return, while expanding the yield on their investment through unique approaches of fund distributions among several assets.

Individuals or groups investing in the stock market are generally concerned with fundamental stock performance characteristics. One such characteristic is leverage. The term leverage is defined as the ratio of a company's long term debt, typically bonds and preferred stock, to its equity in its capital structure. Thus, the greater the long term debt, the greater the leverage.

Another fundamental characteristic of most assets is volatility. Volatility is the relative rate at which the price of an asset (e.g. security, stock, etc,) rises and falls. Volatility can be found by calculating the annualized standard deviation of daily change in price. If an asset has high volatility the price of that asset moves up and down rapidly over short time periods. A low volatility means the price of an asset is stable and rarely changing.

Two typical investment strategies through which an individual or group investing money in the financial markets can benefit are known as “short positions” and “long positions.”

A “long position” is an investment strategy wherein the investor has determined that a purchased stock is likely to rise in price, and intends to benefit from the rising stock price. An investor taking a long position is said to be “holding the shares long.” Thus the investor holds on to the stock expecting to benefit from the potential rise in the stock's price. Bullish investors will often take a long position, expecting a rise in the price of stocks in the future. A long position is taken by investors who hope to benefit from the theory of buying stocks at a low price and selling them at a high price.

A “short position” is an investment strategy wherein the investor has determined that a purchased stock is likely to fall in price and hopes to benefit from the falling stock price. A short position in an asset may have a slightly varying meaning depending on the nature of the asset (e.g. in futures a short position is selling a contract, in stock purchases a short position is selling a borrowed stock and repurchasing it at a lower price). However, generally an investor investing in short positions is referred to as a “short seller”. If an investor wishes to benefit from the falling stock price the investor may borrow the stock from its owner with the intent to sell it. Once the price of the stock has fallen the short seller will repurchase the stock returning it to its owner and keeping the difference, this is known as taking a short position. When an investor is bearish, namely expecting the price stocks to fall, the investor is likely to take a short position in order to benefit from the falling stock prices.

The short seller is normally in debt to his broker, the broker would generally borrow the shares used by the short seller from an individual holding the shares long.

For example, shares in ABC Corporation sell at $5 per share, an investor taking a short position may borrow 100 shares, and sell the shares for $500. Subsequently, as the price of the ABC corporation shares falls to $3 per share, the short seller will repurchase the 100 shares at a price of $300, return the shares to their original owner, and keep the $200 difference.

This practice has the potential for limitless losses, if the shares that one borrowed and sold in fact went up in price, the short seller would have to buy back all the shares at the higher price, losing the difference in price.

Another investment strategy is the purchase of shares in foreign corporations not listed on the U.S. stock market. However, applicable U.S. and foreign laws governing these transactions, as well as fluctuations in the currency exchange rate, may make tracking the performance of such an asset a tedious task. One solution to this is purchasing an American Depositary Receipt (“ADR”). An ADR is a certificate issued by a U.S. bank, an ADR represent shares held by the bank in a foreign country, by either a branch of the bank or a correspondent in the original nation of issue.

A single ADR may represent a variety of share amounts (i.e. a portion of a share, one share or a bundle of shares) sold on an exchange outside of the United States.

ADRs may be “sponsored”, in such an instance the corporation selling its shares on a foreign exchange will provide financial and other information to the bank signing the ADR, and may at least in part, subsidize the management of the ADR. An ADR is subject to the same market risks as the underlying foreign share.

Another investment strategy is known in the art as a “select holdings” strategy. In implementing the select holdings strategy, the holdings of a fund's money managers within their fund segments are analyzed in order to select specific stocks that have been chosen by a significant amount of money managers. Such stocks are then analyzed by an in house system of an investing institution, and ranked according to their current and potential performance. Additional shares of certain stocks are purchased on the basis of such ranking.

This investment strategy is designed to expose a given portfolio to a diverse range of stocks.

However, the “select holdings” strategy has a significant level of risk, including the potential loss of invested principal. This risk is at least in part based on the losses experienced due to an increased diversity of exposure. In general, such portfolios do not grow at a steady rate of return, and typically display a significant level of negative growth. Thus, the structuring, and attempts to increase returns involved in the “select holdings” strategy may actually reduce returns on the investment.

Regardless of the type of investment, investments in public companies (e.g. stock indices, securities, futures contracts, etc,) in the U.S. are subject to the regulations and scrutiny of the United States Securities and Exchange Commission (“SEC”). The SEC is a U.S. government agency responsible for enforcing the federal securities laws and regulating the securities industry/stock market. The SEC regulates and audits the stock market and prevents corporate abuses relating to the offering and sale of securities and corporate reporting.

The SEC has the authority to license and regulate stock exchanges in the United States. SEC may bring civil enforcement actions against organizations and individuals suspected of committing fraud, providing purposely inaccurate information, engaging in insider trading, criminal financial violations, and other violations of securities laws.

All financial reports submitted by companies to the SEC are generally filed in accordance with the Generally Accepted Accounting Principles (“GAAP”). The GAAP is a set of accounting rules used to report financial statements by public companies. Although the United States government does not specifically require the use of standards set forth in the GAAP, the SEC does requires that financial statements submitted by publicly traded companies are filed according to the GAAP. Currently the U.S. GAAP and international accounting practices have several differences, thus international financial reports filed by companies who seek to have their shares traded on U.S. stock exchanges must be reconciled with the U.S. GAAP.

Because current investment strategies are incomplete and uncertain, there is a clear need in the art for a system and method to more effectively manage the risks involved in investing. The present invention overcomes the various deficiencies associated with traditional investment strategies.

### SUMMARY OF THE INVENTION

It is an object of the present invention to provide a stock selection method based on a rich set of fundamental stock characteristics.

It is another object of the present invention to provide an investment strategy with low information losses due to portfolio construction.

Yet another object of the present invention is to establish a direct, intuitive and transparent relationship between portfolio positions and fundamental mathematical asset performance factors that drive return.

It is a further object of the present invention to significantly simplify the optimization of investment strategies.

A further object of the present invention is to reduce the vulnerability to optimization “error maximization”.

It is another object of the present invention to include mathematical asset performance factor correlation and volatility in the stock selection and analysis method.

Yet another object of the present invention is to outperform the performance of known stock indices while maintaining a low realized 12-month tracking error over full market cycles.

Another object of the present invention is to allow for inclusion of transaction cost and portfolio constraints (e.g. short sale constraint) in the investment strategy optimization process.

It is an object of the present invention to generate a portfolio of stocks with well diversified active weights by sector and investment theme.

A further object of the present invention is to increase the dividend yield on investment over a long portfolio without increasing portfolio volatility.

It is a further object of the present invention to achieve higher yields on investment without becoming leveraged in the market.

Still another object of the present invention is to use proceeds from short positions to purchase additional dividend paying names.

It is another object of the invention to maintain a large number of holdings which diversify stock specific risks.

Other objects, features, and characteristics of the present invention, as well as the methods of operation and functions of the related elements of the structure, and the combination of parts and economies of implementation, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems and methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a flow chart depicting the method by which specific stocks are selected for investment in accordance with an embodiment of the present invention.

FIG. 2 is a flow chart depicting the method by which stock selection criteria mathematical asset performance factor weights are determined for each stock selection criteria factor in accordance with an embodiment of the present invention.

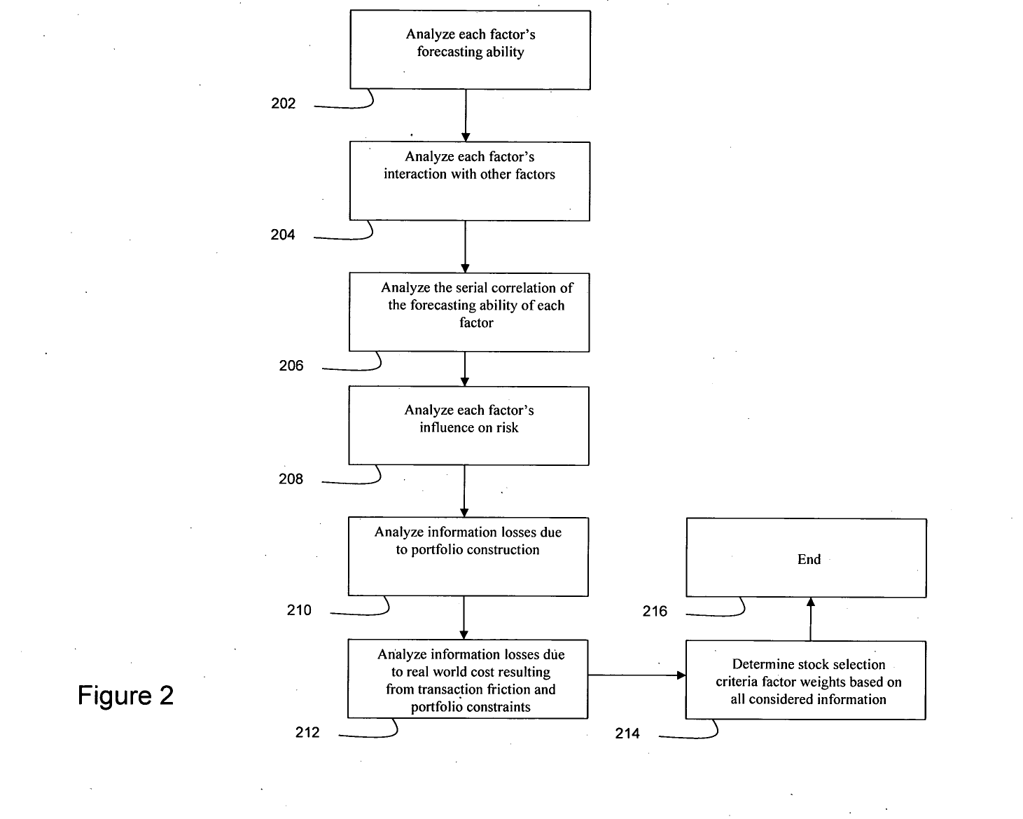

FIG. 3 is a flow chart depicting the method by which the amount of funds to be invested using each investment strategy is determined and invested in accordance with an embodiment of the present invention.

FIG. 4 is a diagram depicting the numerical data set of returns generated when the methods of the present invention are back tested over a period of time for which stock performances are known in accordance with an embodiment of the present invention.

FIG. 5 is a graph depicting the returns generated when the methods of the present invention are back tested over a period of time for which stock performances are known in accordance with an embodiment of the present invention.

FIG. 6 is a diagram depicting the method for distributing funds to be invested in accordance with an embodiment of the present invention.

FIG. 7 is a diagram depicting the system on which the methods of the present invention may be implemented in accordance with an embodiment of the present invention.

### DETAILED DESCRIPTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment of the present invention.

The present invention utilizes individual fundamental stock characteristics such as sector-relative valuation, earnings quality, and earnings momentum. These characteristics provide the best basis for forecasting each stock's return.

Although the present invention is described herein with reference (to investment in stocks, such embodiments are merely exemplary and are not intended to be limiting or represent an exhaustive enumeration of all asset types to which the invention is applicable. Thus, the present invention can be used for investment in a diverse group of assets.

The present invention generates superior returns by frequently and consistently measuring the characteristics of every stock in the eligible investment universe and incorporating these measurements in a rigorous repeatable process that considers both volatility and correlation. The term stocks is used in reference to a diverse collection of assets, and thus is not limited to a specific index or investment type.

Thus, the portfolio construction of the present invention yields the closest possible alignment between fundamental stock characteristics and individual portfolio weights.

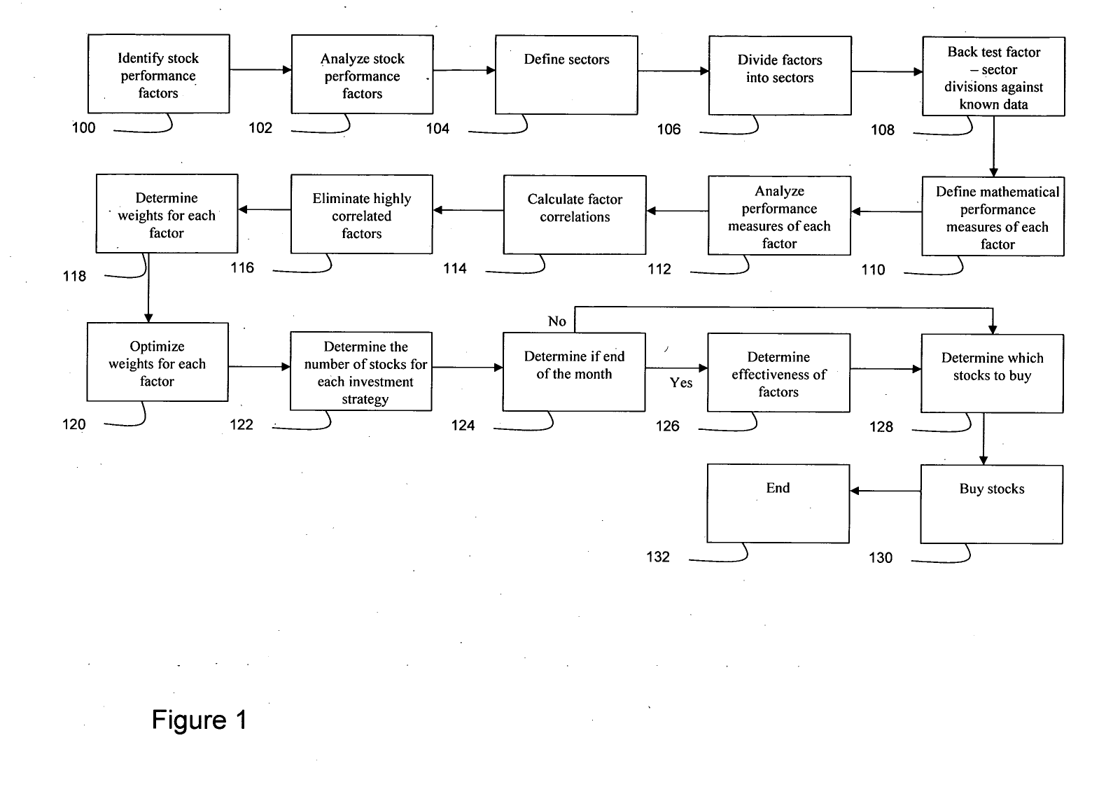

FIG. 1 depicts a method by which specific stocks are selected for investment using the methods of the present invention, as described in detail below.

First, mathematical asset performance factors of stocks are identified in step 100. The stock performance factors are then analyzed for effectiveness in step 102. Specific sectors are defined in step 104, subsequently the identified factors are divided into the defined sectors in step 106. The factor-sector divisions are then back tested to determine effectiveness against known data in step 108. Mathematical performance measures are then defined for each factor in step 110.

The identified performance measures are then analyzed to determine stock performance in step 112. Afterwards, factor correlations are calculated in step 114, highly correlated factors are eliminated in step 116. The weight of each factor is determined in step 118, wherein the weights indicate the significance of each factor in the selection of stocks. The weights are then optimized in step 120. The number of stocks to be used in each investment strategy is determined in step 122.

Subsequently, it is determined whether it is the end of the month in step 124, if it is not the end of the month, stocks are selected for purchase in step 128 and then purchased in step 130. If it is the end of the month, the effectiveness of each factor is determined in step 126, stocks are selected for purchase in step 128 and then purchased in step 130. Upon completion of step 130 the procedure ends in step 132.

Initially, each factor's forecasting ability is analyzed in step 202. The interaction of each factor with other factors is considered in step 204. Subsequently, the serial correlation of the forecasting ability of each factor is analyzed in step 206. Each factor's influence on risk is analyzed in step 208. The information losses due to portfolio construction are then analyzed in step 210. The information losses due to real world cost resulting from transaction friction and portfolio constraints are analyzed. Finally, the stock selection criteria factor weights are determined based on all analyzed information in step 214, the procedure then ends in step 216.

As described above, the present invention entails the identification and analysis of factors, this term refers to fundamental stock characteristics. Research of factors may include a variety of sources: Wall Street research, academic papers, fundamental analysts, as well as any other relevant source.

The factors are generally intuitive and have a foundation in economic and/or behavioral theory. Factors generally demonstrate strong empirical evidence of efficacy as well.

In developing a stock selection model for a specified investment universe the method of the present invention may utilize over two hundred different factors. Each factor is broadly classified into one of four different groups relating to business behavior, management behavior, investor behavior, or valuation.

Business behavior factors are characteristics that measure the performance of the business and include fundamental characteristics like profit margin expansion and return on equity (“ROE”).

Management behavior factors take advantage of the predictable consequences of management decisions. Examples of this type of factor include measures that gauge managers' ability to manage inventories, receivables, and other working capital that impact the quality of earnings.

Investor behavior factors aim to exploit investor biases. For example, anchoring and overconfidence can be exploited with analyst revisions and price momentum.

Finally, valuation factors measure price attractiveness in a cross-sectional and/or time-series context.

While every industry sector exhibits these exploitable anomalies, the particular factor best suited to measure that behavior varies by industry sector. For example, excess returns among bank stocks are driven more by valuation factors such as price-to-book than by business, management, or investment behavior.

On the other hand, technology stocks are not as sensitive to valuation as bank stocks and to the degree that they are, price-to-book is not the factor with the strongest forecasting ability. Instead free cash flow measures are more effective measures of value for technology stocks. To exploit these differences, the method of the present invention accounts for each factor within each sector and, separately, across the entire eligible investment universe.

In examining factor behavior by sector, the method of the present invention devotes considerable importance to defining sectors. The present invention utilizes intelligent industry groupings that combine stocks with similar performance drivers. Sector definitions differ by strategy because the number of stocks available in a given industry varies considerably across growth and value indices. For example, 13 different industry sectors may be used, in developing the small cap growth stock selection model. Evaluating over 700 individual factors across thirteen different economic sectors means evaluating almost seven thousand different factor-sector combinations.

Each factor-sector combination may be back tested and evaluated on the basis of performance, risk, and consistency. During the factor evaluation, over ten different performance measures (e.g. information ratio, batting averages, skewness, etc) are considered. A given factor-sector combination is then reviewed for its performance across multiple portfolio holding periods. Additionally, the factor's performance is then reviewed during different types of markets (e.g. bull markets, bear markets, recessions, etc). Through this initial stress testing only the most powerful and robust factor-sector characteristics are retained.

Screening also involves calculating factor correlations to eliminate factors that are highly correlated. The result of this initial step is the identification of 60 to 80 different factor-sector combinations diversified both across sectors and across behavior classifications.

### Stock Selection Model Development

The initial factor research yields a rich set of fundamental characteristics. Each of these characteristics has an ability to forecast returns at the benchmark level, or, within an individual industry sector. The next step in the process is the determination of appropriate weights for each factor to yield the highest return for a given level of risk. As previously described this determination jointly considers:
Each factor's forecasting ability.
Its interaction with other factors.
The serial correlation of forecasting ability and its influence on risk.
Information losses due to portfolio construction and real world costs due to transaction friction and portfolio constraints.
   The importance of information losses associated with portfolio construction is a significant aspect. The relationship between return per unit of risk, management skill and portfolio construction is generalized into a “Fundamental Law of Active Management” shown below:

IR=IC×TC×√(breadth)

This relationship states that a manager's information ratio (“IR”) is a function of the product of their ability to rank stocks by future return, namely the information coefficient (“IC”), how effectively their rankings are expressed in their portfolio, seen above as the transfer coefficient (“TC”), and the number of stocks they apply their ranking to (“breadth”).

IC and breadth are generally related. Traditionally, managers who attempt to analyze too many stocks (higher breadth) might see their ability to analyze those stocks impaired (lower skill or IC). As for TC, it can be significantly reduced by portfolio constraints, errors in estimating risk parameters such as covariances, and transaction costs. This will result in lower returns as the manager's skill is lost (not ‘transferred’) during the portfolio construction process.

However, the stock selection model of the present invention simultaneously considers IC, TC and breadth in an optimization process. This is possible because individual stock weights are a direct function of a stock's fundamental characteristics, as used in setting up a portfolio according to the methods of the present invention:

Pw=Bw+(Θ_{i=1 to n}×F_{i=1 to n})

### Wherein:

Pw=Weight of a single stock in the portfolio
Bw=Benchmark weight of that single stock
   o_{i=1 to n}=Optimized factor weight (factors 1 to n)
F_{i=1 to n}=Fundamental factors standardized to have mean of 0
   “Parameterizing” the portfolio construction process in this way has significant benefits. Some exemplary benefits are listed below, however these benefits are merely exemplary and the list should not be considered exhaustive:
Establishes direct, intuitive and transparent relationship between portfolio position and fundamental factors that drive return.
Significantly simplifies the optimization process (compared to optimization relying on individual stock return estimates and individual stock covariances). This reduces vulnerability to optimization “error maximization”.
Implicitly includes factor correlation and volatility.
Allows for inclusion of transaction cost and portfolio constraints (e.g. short sale constraint) in the optimization process.
Robust problem definition easily allows a variety of factor and factor structures to be assessed.

An optimization process is conducted in order to determine the weights for each factor that optimizes a loss-penalizing objective function, consistent with the targeted tracking error. The objective function of the present invention is based on 12-month excess returns to better estimate realized tracking error, by accounting for any serial correlation in excess returns.

To provide robust factor weight estimates many optimizations are performed based on bootstrap sampling with replacement of 12-month intervals using 16 years of monthly data. In any one resampled data set, individual sub-periods may be missing or repeated, more than once. This procedure minimizes the possibility of over-fitting the historical data.

Importantly, transaction costs are included in the optimization process. Thus, individual fundamental factors receive weights appropriate to the strength of their forecasting ability including the costs associated with that factor's turnover. Finally, the number of stocks held in a specific strategy is an outcome of the optimization (i.e. it is not a constraint). The number of stocks, (i.e. the breadth in the fundamental law of active management) is optimal given the IC of the fundamental factors of the present invention.

### Model Re-Estimation

The stock selection model estimation of the present invention is on-going, namely the model of the present invention is designed to be constantly adjusted in order to account for changing market characteristics. The structure of the method of the present invention makes it easy to test new fundamental factors, interaction factors and/or conditioning variables.

According to the present invention, a new factor is first tested individually to see if it passes initial screening based on its individual performance. If it appears promising, it is then included in a re-optimization process to see if it adds to the performance of the model. The optimization determines if the factor is added, or, replaces a current factor in the model.

In addition to testing new factors, the individual factors are examined monthly to determine if individual factors may be gaining or losing effectiveness. Furthermore, individual factors are also reexamined annually to adapt for any structural changes in market behavior.

Evidence of secular change in effectiveness is used to determine whether a factor will continue to be included in the factor set fed to the optimization process. These results are then used during the annual model re-estimation, where stock selection models are adapted for any structural changes in market behavior.

### Investment Process Implementation

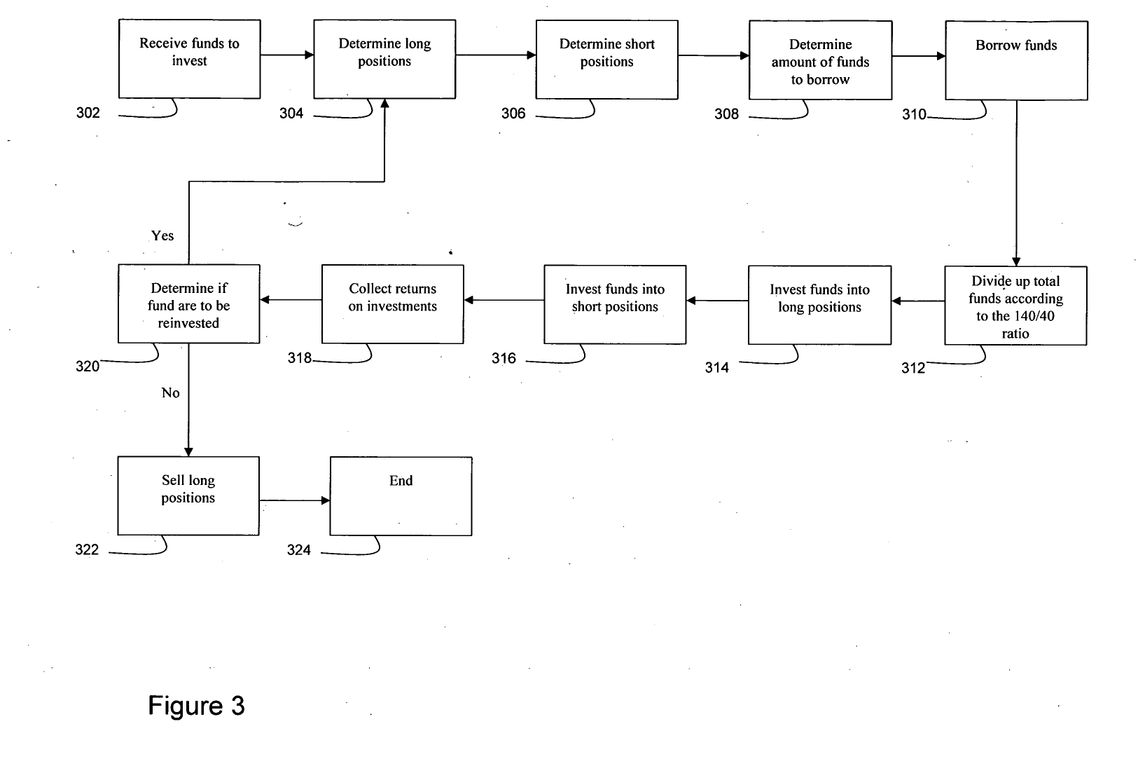

FIG. 3 depicts a method by which the amount of funds to be invested by an investing institution using each investment strategy is determined and invested.

Initially the funds to be invested are received by the investing institution in step 302. The long positions to be purchased are determined in step 304 and the short positions to be purchased are determined in step 306. The amount of funds to be borrowed is determined in step 308, the funds are then borrowed in step 310. The total funds are divided up according to the 140/40 ratio in step 312.

The divided funds are then invested into long positions in step 314 and into short positions in step 316. The returns on each investment are collected in step 318. It is determined whether the funds are to be reinvested in step 320. If the funds are to be reinvested the procedure begins again at step 304.

However, if the funds are not to be reinvested the long positions are sold in step 322, and the procedure ends in step 324.

### Daily Processing of Stock Information

The process of the present invention is inherently disciplined as buys and sells are determined by the above described stock selection and investment models. The information advantage of the present invention is expanded by running the stock selection models daily to incorporate the most recent information on the hundreds of stocks in the investment universes utilized by the present invention. To increase the probability that trades are based on “real information”, all data is audited and closely examined on a periodic basis, specifically the underlying data behind changes in model-determined portfolio weights. Both, filtering and smoothing techniques are also employed in the implementation of the present invention.

When a daily trade list is large enough, trading algorithms are employed to optimally balance market impact and the ability of the method of the present invention to capture excess returns. The present trading approach is also designed to minimize commission costs.

### Factor Attribution and Risk Control

The portfolios created using the method of the present invention are diversified, and would typically hold between 15% to 30% of the names in the benchmark portfolio. In addition, sector allocations may be limited to +/−35% of the benchmark sector allocation.

The portfolios are fully invested, holding cash to a minimum, strictly to facilitate trading and cash flows. Additionally, futures and/or other securities may be used to manage cash flows.

To monitor the risk exposures and tracking error, standard models such as BARRA may be used without departing from the spirit of the present invention. Third party risk models, such as BARRA, provide an independent view of the portfolio's risk profile and sources of unintended exposures, for portfolio's created using the method of the present invention. Additionally an independent proprietary risk model may be utilized for added analysis. Proprietary risk models may also incorporate independent factors, thus the added benefit of ensuring that the portfolios created using the method of the present invention are consistent with the factor models of the present invention.

Similarly, when monitoring performance, both commercial and proprietary tools are utilized. Using the commercial tools, the commonly viewed sector and stock specific contributions to performance are monitored. Using proprietary custom created analysis tools, may provide further insight into exactly how much performance is being contributed by each of the factors. The results of the above monitoring processes are then used as inputs into the annual model re-estimation process.

### Small Cap Growth Strategy

The small cap growth strategy of the present invention is designed to outperform the Russell 2000 Growth Index by at least 4-6% while maintaining realized 12-month tracking error between at least 5-7% over full market cycles.

The research method and design objective of the present invention results in generating a portfolio of between 200 to 400 stocks on average, with well diversified active weights by sector and investment theme. However, a different number of stocks may be utilized in generating a given portfolio, as may be needed by a specific implementation of the present invention, without departing from the spirit thereof.

### Back Tested Performance

The strategies described above are further back tested over a period of time for which stock performances are known (e.g. 1990-2005) in order to determine effectiveness of using the methods of the present invention.

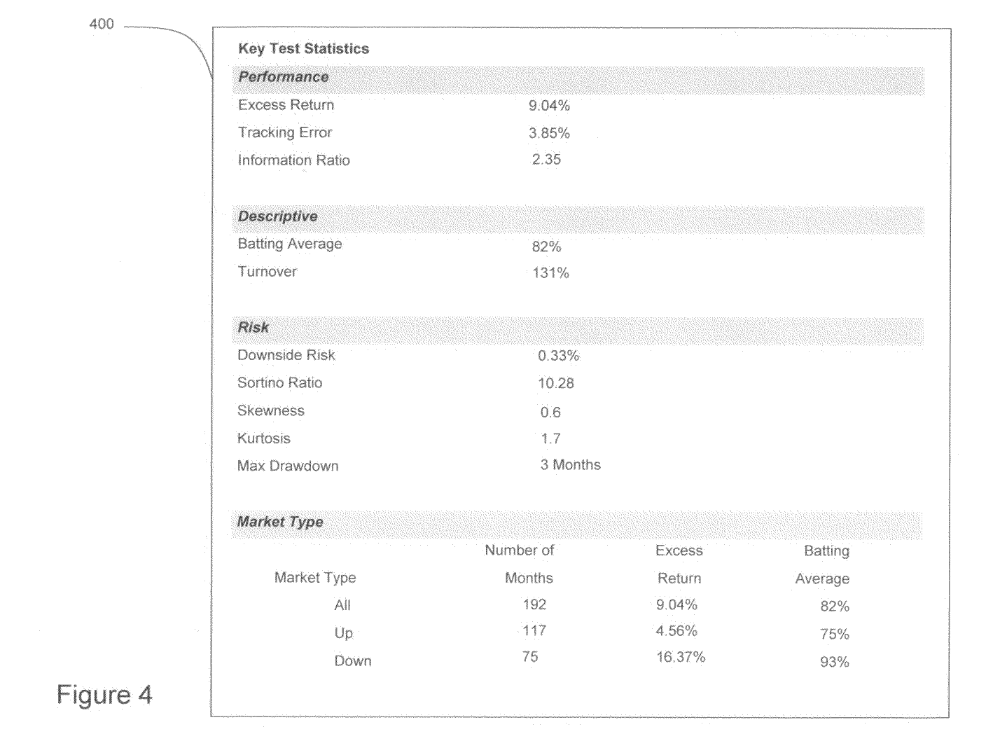

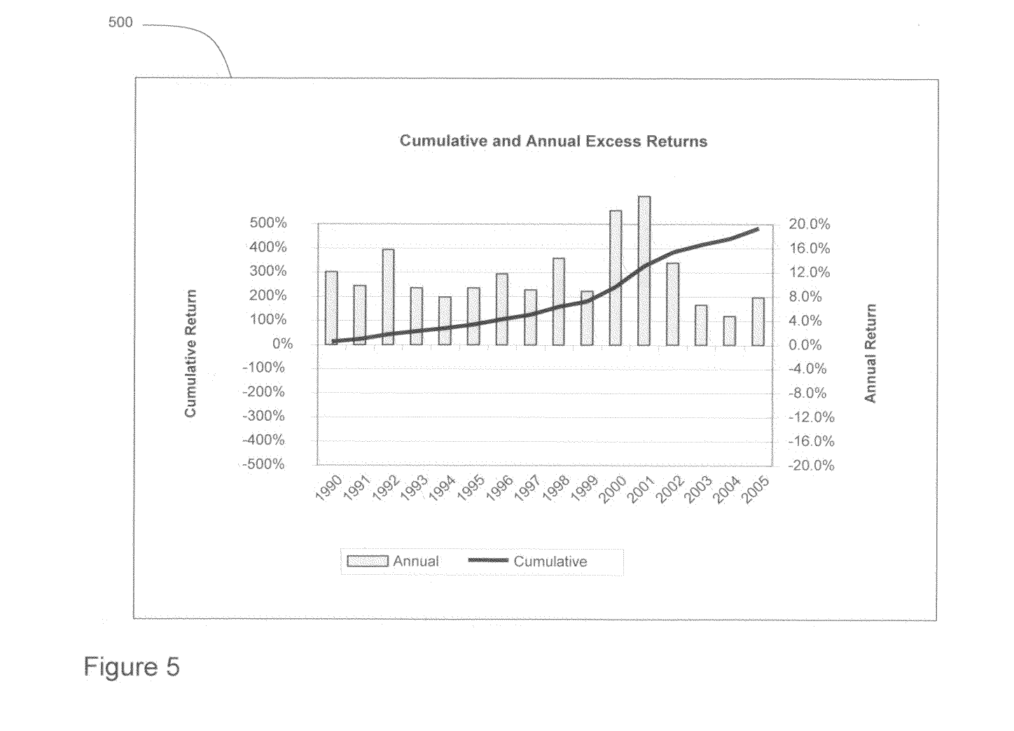

FIG. 4 depicts the numerical data set of returns 400 generated when the methods of the present invention are back tested over a period of time for which stock performances are known. While, FIG. 5 depicts the graph 500 of the returns generated when the methods of the present invention are back tested over a period of time for which stock performances are known.

As shown in FIGS. 4 and 5, when applying the method of the present invention to a period of time where stock performances are well known (e.g. 1990-2005), the method of the present invention creates well performing portfolios.

The portfolio generated using the method of the present invention, whose characteristics are shown in numerical form FIGS. 4 and 5, had an annual excess return of 9% over the Russell 2000 Growth benchmark and a 4% annual tracking error resulting in an information ratio of 2.3.

The model created using the above described methods beat the benchmark in over 80% of the months, 75% during up markets and 93% during down markets. Furthermore, the model achieved these results with a 130% annualized turnover.

### THE 140/40 EMBODIMENT

The 140/40 embodiment of the present invention divides the amount of money a given individual or group wishes to invest into two categories, namely funds invested into long positions and funds invested into short positions. For example, for every $100 invested according to the methods of the present invention an additional $40 is borrowed, to be invested in long positions. Furthermore, an additional $40 is obtained as a federal funds based rebate fee credited by an accredited institution (i.e. Goldman Sachs). Thus, $140 is invested in 75-175 stocks (i.e. invested in long positions), and $40 is shorted (i.e. invested in short positions) in 50-100 stocks.

Thus, %140 of the funds received by an investing institution is invested in long positions, wherein the additional %40 to be invested in long positions is borrowed as a federal funds based rebate fee credited by an accredited institution, and yet another %40 of funds received by the investing institution is invested in short positions. It should be noted that the ratio of funds burrowed to funds received for investment may be adjusted to be at least an additional %40 of funds received by the investing institution for at least %140 to be invested in long positions, or at most an additional %40 of funds received by the investing institution for at most %140 to be invested in long positions, without departing from the spirit of the present invention.

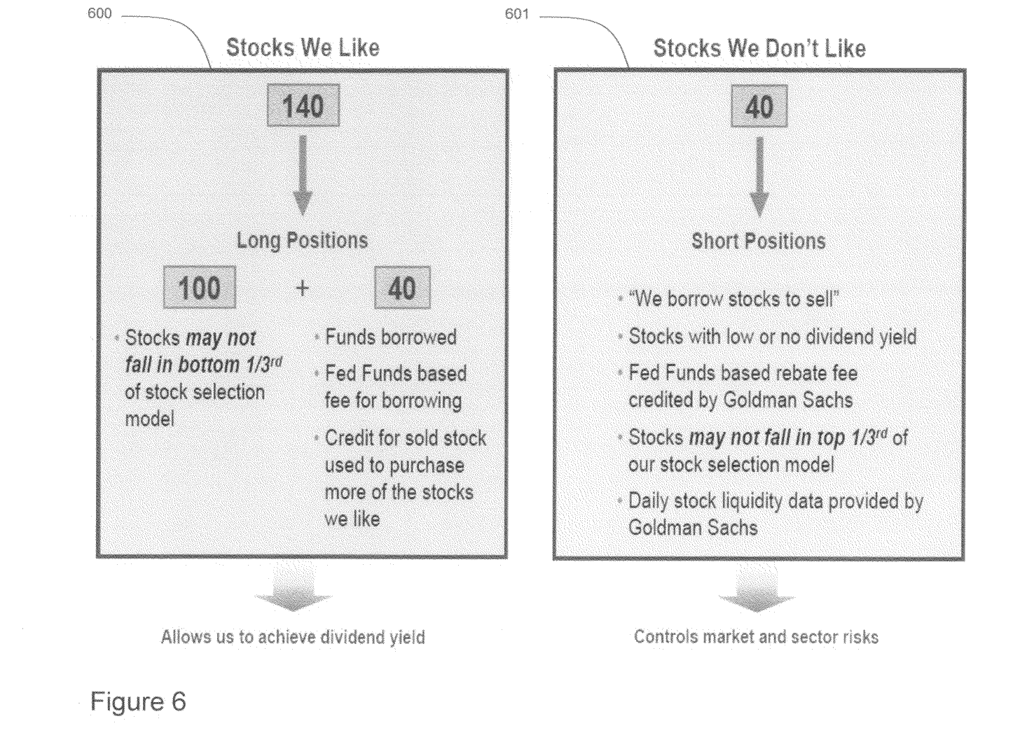

FIG. 6 depicts an illustration of the method for distributing funds to be invested by investment method in accordance with the above example. In the above example $140 is invested 600 in long positions, while $40 is invested 601 in short positions.

The long positions are chosen on the basis of dividend yield and the above described stock selection methods of the present invention, these stocks generally, do not fall into the bottom ⅓^{rd} ranked of the overall universe of selected stocks. Purchase of the long positions allows achievement of the desired dividend yield.

The short positions are chosen on the basis of low to no dividend yield and the above described stock selection methods of the present invention, these stocks generally, do not fall into the top ⅓^{rd} ranked of the overall universe of selected stocks. Purchase of the short positions allows for control of market and sector risk.

In the above example of the $100 investment, the $140 invested 600 in long positions is divided into two amounts, namely the initial $100 which is invested in long positions, and $40 which is borrowed from a lending institution (e.g. federal lending) based on a borrowing fee, and is further invested in long positions. When stocks are sold the borrowed money is returned to the lending institution and the return is further invested in the portfolio (i.e. to purchase long positions).

Further, the $40 invested 601 in short positions is used to borrow stocks with low or no dividend yield, to be later sold, while the original lender is refunded. These stocks may be chosen based on daily stock liquidity data provided by a financial institution (i.e. Goldman Sachs). These funds may be realized by a federally funded rebate fee credited by a financial institution (e.g. Goldman Sachs).

This method of investment allows for advantages over existing methods in several areas such as, but not limited to: tax efficiency, transaction costs, sector neutrality, market performance, pure equity exposure, short sales which allow for purchase of additional dividend paying names, diversity of stock specific risks due to a large number of holdings, and overall higher yield without becoming leveraged to the market.

Furthermore, the 140/40 embodiment of the present invention allows for increases in dividend yield on average of about 1.5% to 3.0% without increasing portfolio volatility, specifically for long position portfolios. The 140/40 embodiment of the present invention creates an increase in the generated portfolio's exposure to quality characteristics from the stock selection model described above.

The present invention diminishes the market leverage risks. Such risks include increased systematic risk, the leverage of each position, and increased exposure to the generated portfolio's theme (e.g. dividend yield). One method by which the present invention mitigates the risks of becoming leveraged is by using additional leverage to buying new positions rather than reinvesting more of the positions already in use.

Additionally, the present invention diminishes the risks involved in short positions (“shorting”). Such risks include stock price rises which pressure investors with short positions to cover as well as raise the price even further (“short squeeze”), unlimited loss potential, and different volatility characteristics on the short side. A number of ways the present invention mitigates the risks of shorting are continually monitoring hard to borrow lists and investing only in easy to borrow lists, managing the overall portfolio risks using daily risk reports (i.e. volatility reports, correlation reports, etc), diversification across a large number of short positions, and strict rules on when to cover a shorted security depending on the short security's size in the portfolio.

Thus, an advantage of the present invention over existing systems is that portfolios generated using the above described methods have distinctive performance characteristics which do not simply mimic a single index.

Additionally, the present invention may utilize ADRs. Some advantages of using ADRs are: quotes and dividends are received in U.S. dollars, the regulations involved are clear and settled in the U.S., foreign investment restrictions are not applicable, the transactions are governed by the SEC and are compliant with U.S. GAAP, information required for the investment process is easily accessible, investment is possible in at least 1,900 sponsored depository receipts from over 70 countries, and clearing as well as trading and settlement expenses associated with direct investment in foreign markets are illiminated. However, the methods of the present invention may also be applied to international stocks.

Although the methods of the present invention have been described in terms of stock selection and purchase, such embodiments are merely exemplary, and the methods described herein can be applied to any type of investment asset without departing from the spirit of the present invention.

Furthermore, a significant benefit of the present invention, is that the investment strategies of the present invention allow to maximize the dividend yield versus the volatility trade-off. Simply put, the present invention provides a higher dividend yield per unit of volatility than other investment strategies known in the art.

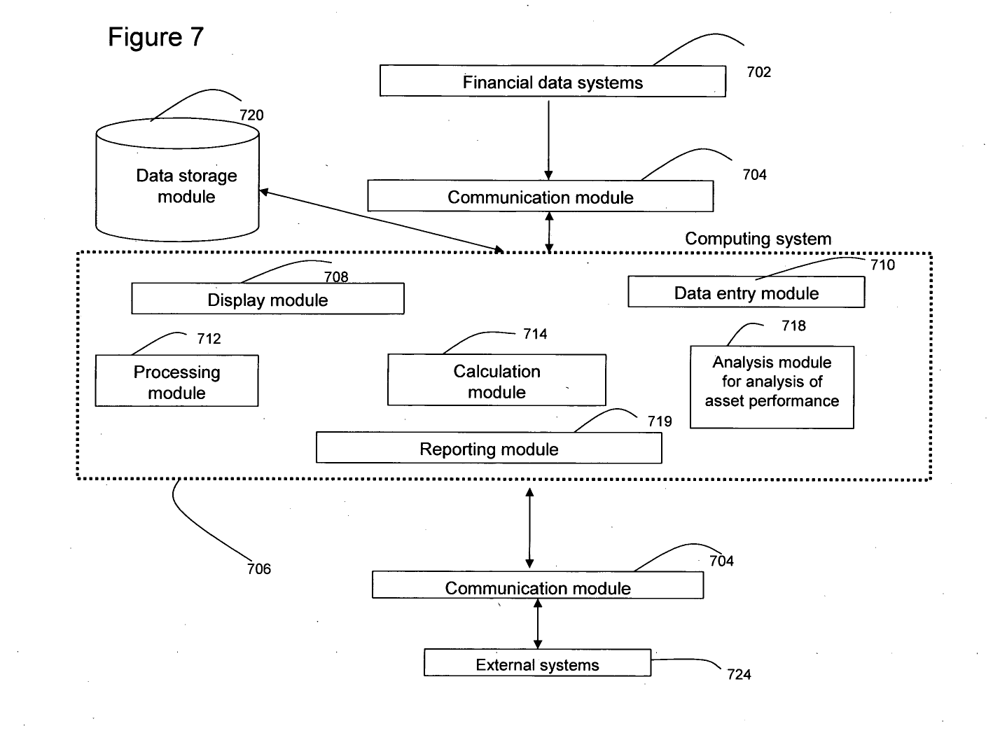

FIG. 7 depicts an embodiment of a system on which the methods described above may be implemented. Asset performance data is received from financial data systems 702 by the computing system 706 via a communication module 704. The communication module 704 transmits and receives data, to and from the computing system 706 via any standard electronic means known in the art. The financial data system 704 may be internal or external to the computing system 706. The computing system 706 consists of: a display module 708, data entry module 710, processing module 712, calculation module 714, a reporting module 719 for generating reports of asset performance and an analysis module 718 for analysis of asset performance. Furthermore, the system may be equipped with an additional communication module 704 for passing asset related information to an external system 724, as well as receiving information from the external system 724.

While the present invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A system for identifying and selecting at least one asset for investment comprising:
a data storage module for storing information associated with said at least one asset;
a calculation module for identifying mathematical asset performance factors and calculating correlations for said mathematical asset performance factor; and
a computing system in electronic communication with said data storage module and at least one financial data system, said computing system comprising:
an analysis module for performing analysis of said at least one asset and eliminating said mathematical asset performance factors with a high level of correlation; and
a processing module for selecting said at least one asset for investment at least in part based on said remaining mathematical asset performance factors using a plurality of investment strategies that at least in part comprise investing in short positions and investing in long positions and outputting said at least one asset for investment according to said plurality of investment strategies.

2. The system of claim 1 wherein said computing system includes a display module, a data entry module, and one or more communication modules.

3. The system of claim 1 wherein said computing system includes an additional analysis module for analyzing said mathematical asset performance factors for effectiveness and outputs the mathematical asset performance factors.

4. The system of claim 1 wherein said computing system includes an additional processing module for defining industry sectors and assigning relevant mathematical asset performance factors into said industry sectors and back testing said assignment against known asset performance data in order to determine effectiveness of said assignment.

5. The system of claim 1 including an additional calculation module for determining a weight for each mathematical asset performance factor.

6. The system of claim 5 wherein said weight for each mathematical asset performance factor is determined by at least one of the following: a mathematical asset performance factor's forecasting ability, a mathematical asset performance factor's interaction with other mathematical asset performance factors, the serial correlation of the forecasting ability of each mathematical asset performance factor, and a mathematical asset performance factor's influence on risk of investment.

7. The system of claim 2 wherein said computing system includes a communication module for receiving information from at least one financial data system and a second communication module for passing asset related information to an external system.

8. The system of claim 1 wherein said funds are invested in at least one asset according to information received from said financial data system and wherein data related to investment of said funds is transmitted to the financial data system.

9. The system of claim 7 wherein said at least one asset is purchased by said external system in accordance with said asset related information.

10. The system of claim 1 wherein said plurality of investment strategies includes a strategy intended to increase the dividend yield.

11. A method for identifying and selecting at least one asset for investment, the method comprising the steps of:
identifying mathematical asset performance factors;
calculating correlations for the mathematical asset performance factor;
identifying mathematical asset performance factors with a high level of correlation;
eliminating the mathematical asset performance factors with the high level of correlation;
selecting the at least one asset for investment at least in part based on the remaining mathematical asset performance factors using a plurality of investment strategies that at least in part comprise investing in short positions and investing in long positions; and
outputting the selected asset for investment.

12. The method of claim 11 and further comprising the steps of:
analyzing mathematical asset performance factors for effectiveness; and
outputting the mathematical asset performance factors.

13. The method of claim 11 and further comprising the steps of:
defining industry sectors;
assigning relevant mathematical asset performance factors into the industry sectors; and
back testing the assignment against known asset performance data in order to determine effectiveness of the assignment.

14. The method of claim 11 and further comprising the step of determining a weight for each mathematical asset performance factor.

15. The method of claim 14 wherein the weight for each mathematical asset performance factor is determined by at least one of the following: a mathematical asset performance factor's forecasting ability, a mathematical asset performance factor's interaction with other mathematical asset performance factors, the serial correlation of the forecasting ability of each mathematical asset performance factor, and a mathematical asset performance factor's influence on risk of investment.

16. The method of claim 11 wherein the plurality of investment strategies includes a strategy intended to increase the dividend yield.

17. A method for investing funds in at least one asset, the method comprising the steps of:
receiving funds;
determining long positions for the at least one asset;
determining short positions for the at least one asset;
determining amount of additional funds to borrow based at least in part on the funds received and the long and short positions determined;
borrowing the additional funds;
outputting and investing in the determined long positions; and
outputting and investing in the determined short positions;
wherein borrowing the additional funds based at least in part on the funds received comprises borrowing funds at a ratio of at least 40% of the amount of funds received to be invested in long positions out of at least 140% of the amount of funds received intended for investment in long positions; and
borrowing at a ratio of an additional said at least 40% of the amount of funds received to be invested in short positions for the at least 140% of the amount of funds received invested in long positions.

18. The method of claim 17 and further comprising the step of collecting a return on the long positions.

19. The method of claim 17 and further comprising the step of collecting a return on the short positions.

20. The method of claim 17 and further comprising the step of selling the long positions.

21. The method of claim 19 wherein the step of investing in the short positions comprises borrowing assets with an expected decrease in value.

22. The method of claim 21 wherein the step of collecting a return on the short positions further comprises the steps of:
selling the borrowed assets with an expected decrease in value; and
repurchasing the borrowed assets with an expected decrease in value.

23. The method of claim 19 and further comprising the step of reinvesting the return collected on the short positions.

24. A method for determining an investment allocation in at least one asset, the method comprising the steps of:
receiving funds;
determining long positions for the at least one asset;
determining short positions for the at least one asset;
determining amount of additional funds to borrow based at least in part on the funds received and the long and short positions determined;
outputting the determined long positions; and
outputting the determined short positions;
wherein said plurality of investment strategies includes a strategy intended to increase the dividend yield.

25. A method for investing funds in at least one asset, the method comprising the steps of:
receiving funds;
determining long positions for the at least one asset;
determining short positions for the at least one asset;
determining amount of additional funds to borrow based at least in part on the funds received and the long and short positions determined;
borrowing the additional funds;
outputting and investing in the determined long positions; and
outputting and investing in the determined short positions;
wherein borrowing the additional funds based at least in part on the funds received comprises borrowing funds at a ratio of a given percentage of the amount of funds received to be invested in long positions out of 100% plus said given percentage of the amount of funds received intended for investment in long positions; and
borrowing at a ratio of an a further amount said given percentage of the amount of funds received to be invested in short positions for the 100% plus said given percentage of the amount of funds received invested in long positions.
